(19) United States
(12) Patent Application Publication
(10) Pub. No.: US 2014/0007968 A1
(43) Pub. Date: Jan. 9, 2014

(54) APPARATUS AND METHOD FOR INTERNAL REPAIR OF ROUND AND NON-ROUND CONDUITS

(71) Applicant: Lembit MAIMETS, Richmond Hill (CA)

(72) Inventor: Lembit MAIMETS, Richmond Hill (CA)

(21) Appl. No.: 13/926,430

(22) Filed: Jun. 25, 2013

Related U.S. Application Data
(60) Provisional application No. 61/668,298, filed on Jul. 5, 2012.

(51) Int. Cl. F16L 55/165

(52) U.S. Cl. CPC F16L 55/165
USPC 138/98

(57) ABSTRACT

A method and apparatuses for rehabilitating pipes, conduits, tunnels, culverts, and other such conveyances, particularly for repairing and/or for reinforcing such pipes. A metal or plastic core collapsed around a longitudinal axis adapted to be expanded within the conduit at a site of repair. A cement grout or other suitable material is used to fill the annulus between the expanded apparatuses and the host pipe to form a composite repair/reinforcing structure.

### CROSS-REFERENCE TO RELATED APPLICATION

This application is based upon U.S. Provisional Patent Application No. 61/668,298, filed Jul. 5, 2012, the disclosure of which is hereby incorporated by reference thereto in its entirety, and the priority of which is claimed under 35 USC § 119(e).

### BACKGROUND

The invention relates to methods and apparatuses for rehabilitating pipes, conduits, tunnels, culverts, and other such conveyances, without excavation or dismantling the part of a conveyance. More particularly, the invention relates to methods and apparatuses for repairing damaged, weakened, or leaking conduits with round or non-round shapes, such as a horseshoe or rectangular cross-sectional profile.

### BRIEF DESCRIPTION OF DRAWINGS

Features and advantages of the present invention will become apparent from a review of the detailed description of exemplary embodiments of the invention, which follows, when considered in the light of the accompanying drawings, in which:

FIG. 1 is a schematic cross-sectional view of a re-lining arrangement (hereinafter referred to as a sleeve) positioned within a host pipe having a horseshoe cross section, the sleeve being shown in collapsed position;

FIG. 2 is a cross-sectional view illustrating the same sleeve in the installed position;

FIGS. 3, 4a, and 4b are cross-sectional views of the same host pipe with horseshoe cross section illustrating another embodiment of invention;

FIGS. 5, 6, and 7 are cross-sectional views of the sleeve positioned within a host pipe having a rectangular cross section;

FIGS. 8 and 9 are cross-sectional views of the sleeve positioned within a host pipe having a round or oval cross section.

### DETAILED DESCRIPTION

Reference is made to U.S. Pat. No. RE30,929 for descriptions of the state of the art in the field of endeavor to which the present invention relates, the disclosure of the patent hereby incorporated by reference thereto in its entirety.

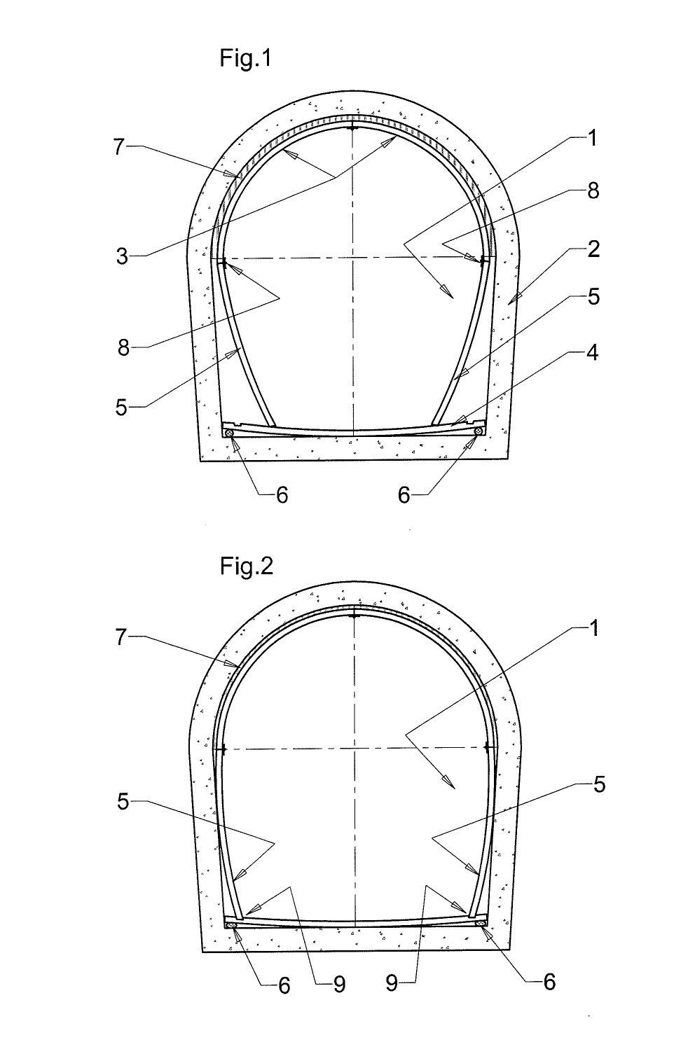

FIG. 1 shows a repair sleeve 1 or core in the collapsed pre-installation configuration. The sleeve 1 for internal repair pipes, conduits, and tunnels in accordance with the invention is shown positioned within a damaged host pipe 2 having a horseshoe cross section. The repair sleeve comprises of crown segment or segments 3, invert segment 4, locking flaps 5, resilient padding 6 and 7 located at the ends of the sleeve 1. The choice of sleeve 1 material, for instance PVC, is determined by the chemical regime in the pipe. The thickness of the sleeve 1 material is determined by the dimensions of the host pipe 2 and the external loads applied to said pipe 2.

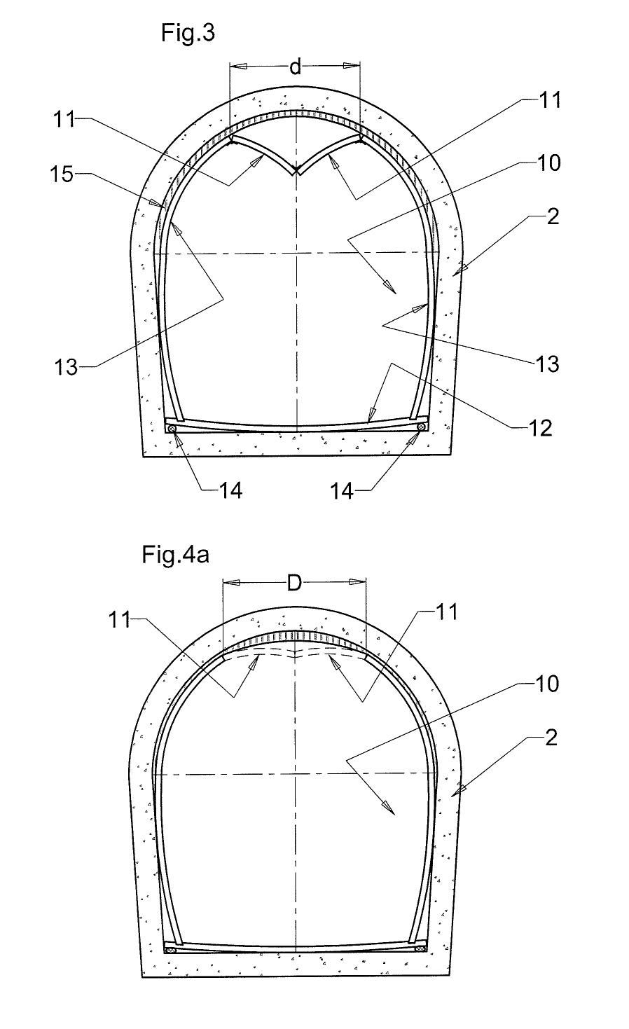

The repair sleeve 1 in the collapsed pre-installation configuration is forming closure which the circumferential length smaller than the circumferential length of the sleeve 1 in the installed position shown in FIG. 2.

In another aspect of the invention, elastomeric or metal strips or hinges 8 join said segments 3 and 5.

FIG. 2 shows the repair sleeve 1 in the installed position. In this position, the flaps 5 are fixed in grooves 9 and so forming the close loop configuration with circumferential length of the sleeve 1 larger than in the collapsed pre-installation configuration and the resilient padding 6 and 7 are compressed between the host pipe 2 walls and the repair sleeve 1. The compressed resilient padding 6 and 7 create reactive force to fix the sleeve 1 in the installed position.

In another aspect of the invention, one of the locking flaps 5 can be located in the groove 9 in the collapsed pre-installation position. In such a case, only one flap 5 can be considered as a locking flap which is dedicated to increase the circumferential length of the sleeve 1 in the installed position.

In yet another aspect of the invention, a chemical or cementitious grout can be applied into the space between the host pipe 2 walls, the repair sleeve 1, and resilient padding 6 and 7.

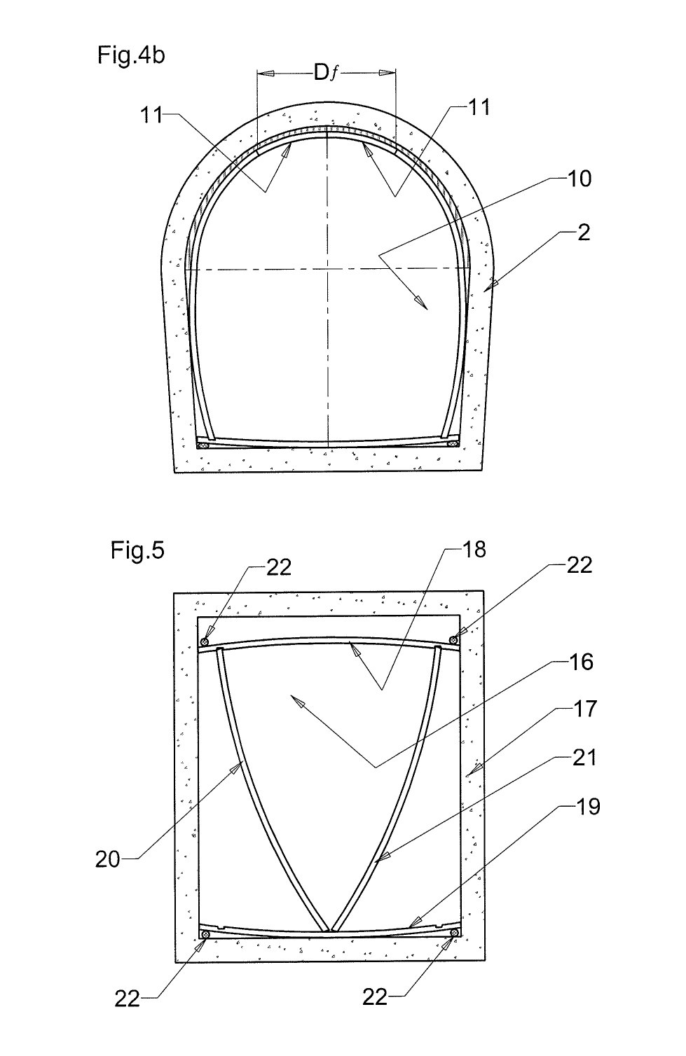

FIG. 3 illustrates an alternative embodiment of the same damaged horseshoe host pipe or tunnel 2 with repair sleeve 10 in the collapsed pre-installation configuration. The sleeve 10 comprises locking flaps 11 located in the crown arch area of the tunnel 2, invert segment 12, lateral segments 13, and resilient padding 14 and 15 located at the ends of the sleeve 10. In this pre-installation configuration the sleeve 2 has a shorter collapsed perimeter than in the installed expanded position (by consideration that the collapsed perimeter includes the shortest distance “d” between locking flaps 11).

FIGS. 4a and 4b show the repair sleeve 10 in the installed position. In this position, the flaps 11 passed the straight line where the flaps were being subjected to maximum compression stress because of the largest perimeter with largest distance “D” (see FIG. 4a) and locked in final expanded position with slightly smaller distance “D_{f}” (FIG. 4b).

A chemical or cementitious grout can be applied into the space between the host pipe 2 walls, the repair sleeve 10, and resilient padding 14 and 15. The grout when it is cured eliminates the resiliency of said padding 14 and 15, and correspondingly increases the rigidity and structural strength of the repair sleeve 10.

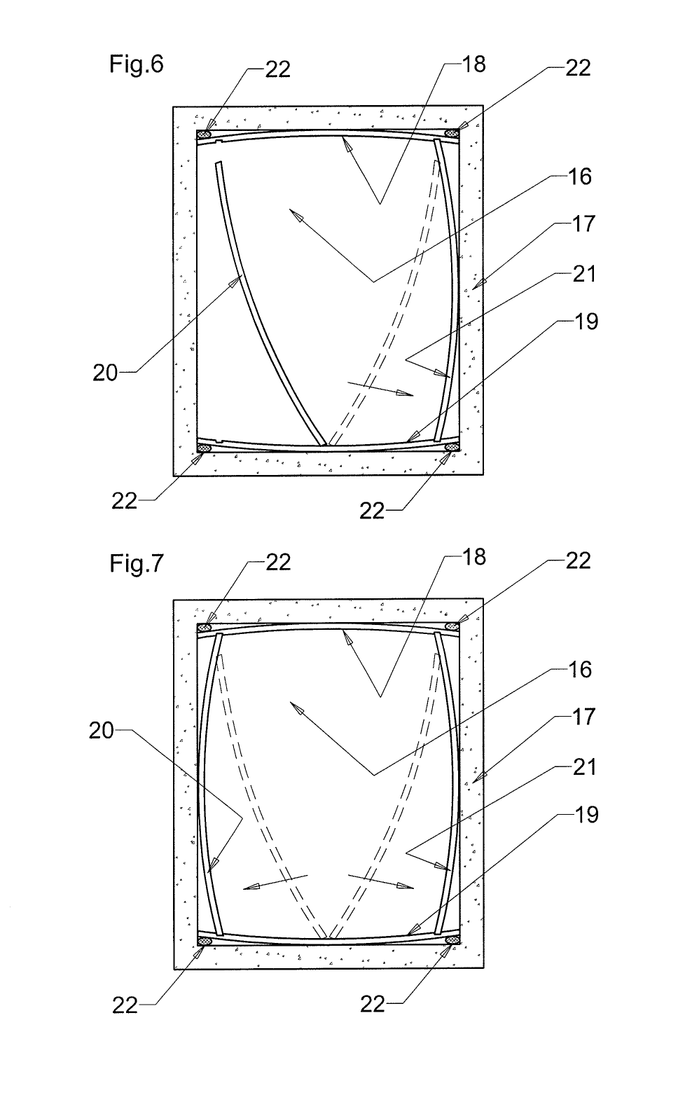

FIGS. 5, 6, and 7 in accordance with another embodiment of the present invention, depict the repair sleeve 16 in pre-installation and installed positions in the rectangular tunnel 17. The sleeve 16 comprises crown segment 18, invert segment 19, locking flaps 20 and 21, and resilient padding 22.

A chemical or cementitious grout can be applied into the space between the tunnel 17 walls, the repair sleeve 16, and resilient padding 22.

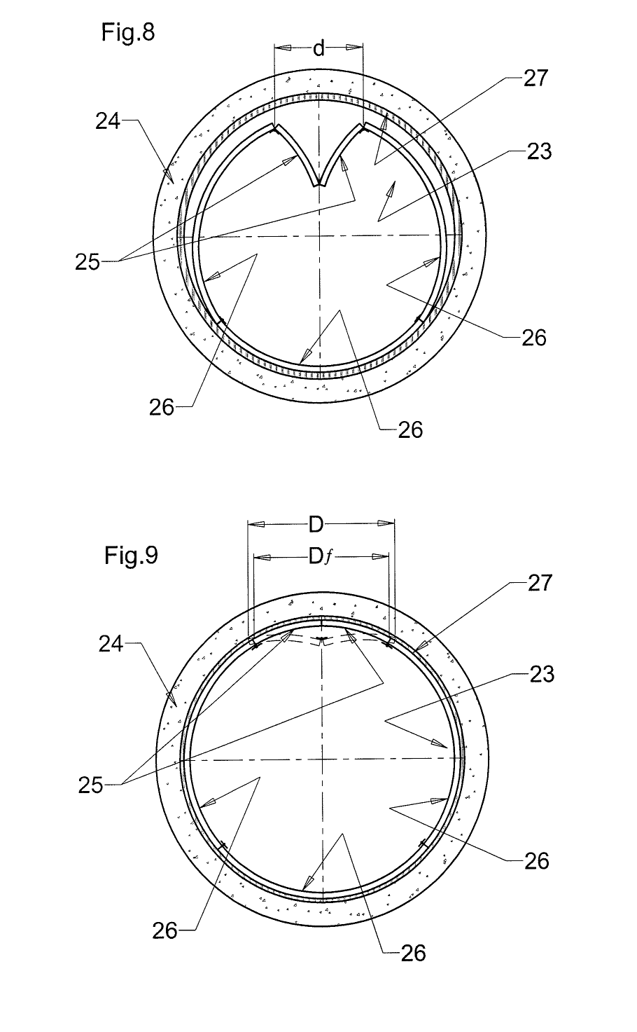

FIGS. 8 and 9 show a repair sleeve 23 in the pre-installation and installed positions. The sleeve 23 for internal repair pipes, conduits and tunnels in accordance with the invention positioned within a damaged host pipe 24 having a round or oval cross section. The sleeve 23 comprises locking flaps 25 located in the crown arch area of the pipe 24, segment or segments 26, and resilient padding 27 located at the ends of the sleeve 23. The quantity of segments 26 depends on host pipe and/or access point dimensions. In the FIGS. 8 and 9 are shown three segments 26.

In the pre-installation configuration (FIG. 8) the said sleeve 23 has shortest collapsed perimeter because the collapsed perimeter includes the shortest distance “d” between locking flaps 25. In the installed position (FIG. 9), the flaps 25 passed straight line where the flaps were being subjected to maximum compression stress because of largest perimeter (with largest distance “D”) and locked in final expanded position with slightly smaller distance “D_{f}”.

A chemical or cementitious grout can be applied into the space between the host pipe 24 walls, the repair sleeve 23, and resilient padding 27.

The aforementioned sleeves can be installed by the use hydraulic cylinders in horizontal, vertical, or both positions.

The plurality of the aforementioned sleeves can be installed continuously in the case of the long continuous damage in the host pipe.

Alternative constructions are also possible without departing from the scope of the invention.

The invention is not limited to the embodiments described hereinabove, and includes all technical equivalents that fall within the scope of the claims that follow.

In addition, at least because the invention is disclosed herein in a manner that enables one to make and use it, in view of the particular disclosure of exemplary embodiments, the invention can be practiced in the absence of any additional element or additional structure that is not specifically disclosed herein

1. An apparatus for internal repair of round and non-round pipes, conduits, culverts, and tunnels comprising:
a metal or plastic core collapsed around a longitudinal axis adapted to be expanded within the conduit at a site of repair, and a sealing structure surrounding said core;
said core comprising a few transversely extended segments adapted to be connected together at corresponding ends to form a close loop;
one or two segments from aforementioned few segments being adapted to be folded or moved inside the close loop to provide smaller perimeter of said close loop.

2. A repair apparatus according to claim 1, wherein:
said sealing structure comprises a plurality of solid resilient O-rings applied over the outer surface of said core.

3. A repair apparatus according to claim 1, wherein:
said sealing structure comprises a plurality of resilient paddings applied over the outer surface of said core.

4. A repair apparatus according to claim 1, wherein:
the plurality of said cores adapted to be installed continuously;

5. A repair apparatus according to claim 1, wherein:
said core comprises a flexible structure to connect said adjacent segments.

6. A method of the internal repair of round and non-round pipes and tunnels comprising:
connecting together the segments of a metal or plastic core to form a collapsed close loop;
applying resilient O-rings or padding over the outer surface of said core;
inserting said repair apparatus within the conduit at a site to be repaired;
expanding said repair apparatus to lock said apparatus into configuration similar to host pipe configuration and to compress said resilient O-rings and/or padding between the inner surface of the pipe and said repair apparatus;

7. The method of claim 6, further comprising:
filling the annulus formed between the outer surface of the repair apparatus and the interior of the host pipe with a material to bind the liner and the host pipe to form a composite structure.
